(19) United States
(12) Patent Application Publication
(10) Pub. No.: US 2013/0138526 A1
(43) Pub. Date: May 30, 2013

(54) Method and System for group pricing of, and negotiation for, goods and services

(71) Applicant: James D. Petruzzi, Houston, TX (US)

(72) Inventor: James D. Petruzzi, Houston, TX (US)

(21) Appl. No.: 13/676,613

(22) Filed: Nov. 14, 2012

Related U.S. Application Data
(60) Provisional application No. 61/563,596, filed on Nov. 24, 2011.

(51) Int. Cl. G06Q 30/06

(52) U.S. Cl. CPC G06Q 30/0605
USPC 705/26.2

(57) ABSTRACT

A system for pricing goods or services has a database of members that join through a social networking site where the members have input pertaining to goods or services, identify one or more products or services they desire to purchase, a processor determines whether a good or service is desired by a sufficient number of members to justify bidding on that good or service, there is communication of the members' desire to purchase at a target price, and an acceptance of the price by said purveyor or a boycott of such purveyor by said members. The members'wish lists and desired aggregate product choices and price points are calculated to arrive at a discounted target price. issues of interest to members may be the focus of the boycott of related goods or services or to boycott a good or service associated with an entity to achieve societal or government change.

### CROSS REFERENCE RELATED APPLICATIONS

This application takes priority from provisional application for patent Ser. No. 61/563,596 entitled “Method and System for group pricing of, and negotiation for, goods and services” and incorporates it in this application as if fully set forth herein.

### FIELD OF THE INVENTION

The present invention relates to consumer buying and more particularly to a method and system for group pricing for goods and services.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows a schematic flow chart of the process flow for a system according to a preferred embodiment of the invention.

FIG. 2 shows schematic depiction of a screen from website of a system according to a preferred embodiment of the invention.

FIG. 3 shows a flow chart of operation steps according to a preferred embodiment of the invention.

### BACKGROUND OF THE INVENTION

Numerous attempts have been made to form consumer or pricing unions to negotiate reduced pricing from suppliers of goods and services. Earlier attempts have typically involved a club or membership organization that negotiates advantageous pricing on behalf of the members of the group. These organizations usually charge membership fees and are limited to a class of goods or services. Further, they often have minimum purchasing requirements or other restrictions to membership or to the benefits of the organization.

Other buying modalities, such as warehouse selling, involve membership and the supply of numerous goods, but pricing is in the control of the organization and not the members themselves. Similarly, consumers have attempted to boycott various companies around products or social issues, but website for such boycotts lack any enforcement mechanism or structured approach to achieve a reduction in price or concession from the boycotted entity.

Thus, there exists a need for a consumer or buyer group or union that uses the internet and social networking media to organize product-by-product buying through the effective threat of a consumer boycott to a particular good or provider of goods. Further, the system would involve notification of large groups of members after a critical number of desired goods or services are demanded by the group to initiate the boycott or group effort to effect a price change. Further, the system would use purchaser pricing software to negotiate the best price on behalf of the consumer group, apart from the price dictated by the group action. Further, the system would allow for users to boycott around social issues with the credible threat of boycotting a good or service associated with or sold by the boycotted entity.

### DETAILED DESCRIPTION OF THE PREFERRED EMBODIMENTS

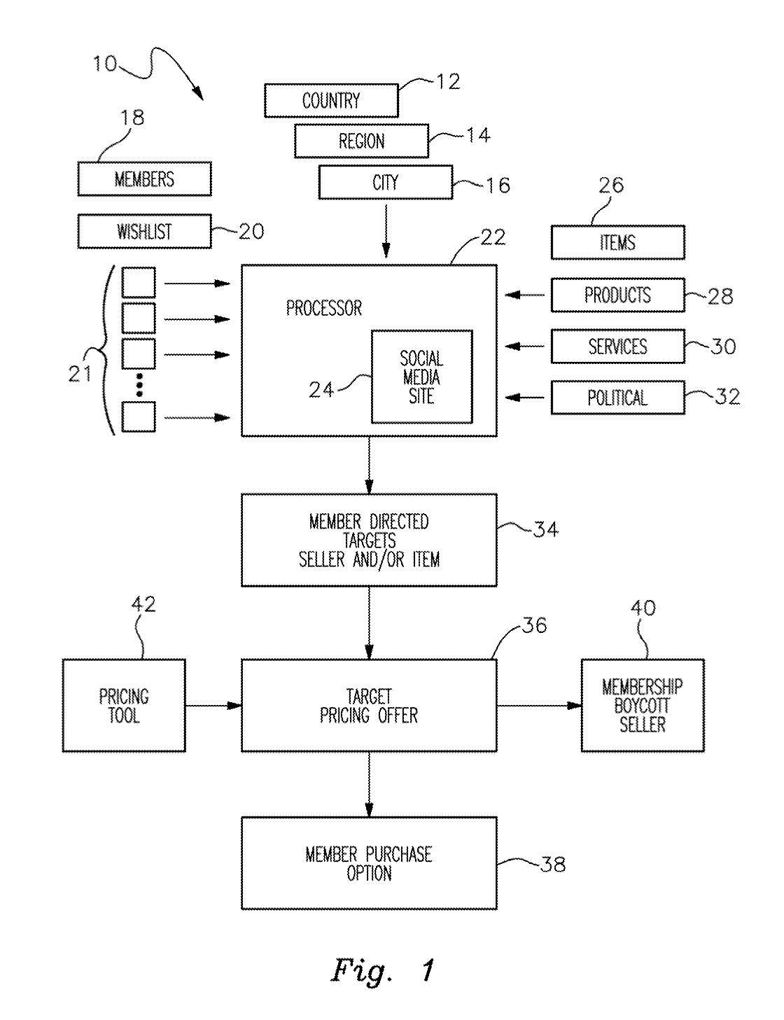

Referring now to FIG. 1, there is shown a flow chart of the preferred embodiment of the invention. A social networking site 24 is formed of members having an interest in achieving lower prices on goods and services. Social media sites are organized by locale, city 16, region 14, country 12 or any other geographic or subject matter criteria. This allows members in a specified locale to organize and form buying groups to be explained later.

Social media site 24 (also known as a social networking site) is integrated with processor 22 that is tied into a server, the cloud, and or a website for interaction with Internet users. Members 18 join the social media site via the internet or other mechanisms including text or email, and formulate wish lists 20 of potential products 21 to generate a list of desired items 26. The members 18 are also presented with pull down menus from items 26 which may include products 28, services 30 and political issues 32. In other instances items 26 may be suggested by members for presentation to other members and may form an item on list. Wish lists 20 are developed by each member or suggestions of a product or service for which a member wants to see if a pricing drop can be achieved. Wish list information may be inputted by any of a variety of mechanisms including the internet, phone, text, or other electronic systems. The processor would assess the members input and develop a list of top products or services (hereinafter targets) for initiation of a pricing reduction. Members may also be queried to identify a price at which they would purchase an item and the processor would in turn calculate average agreed pricing to arrive at a target price as discussed below.

Based on the wish lists 20 that are developed, once a critical predetermined mass of members selecting a particular item is reached, items are identified at step 34 for a pricing offer at step 36. A target at step 36 is chosen by the processor or internet or social media operator. Pricing tool 42 uses pricing algorithms using available data pertaining to sellers, quantities, inventory, shipping and other data which is in turn employed to create a pricing proposal to a particular seller of goods or services. It may also be used to announce a target price desired by the membership from any supplier of the good or service. For example, prices from the internet could be obtained and an average current price developed. The processor would compare that price to members' wish list pricing and generate a reduced pricing target based on an algorithm, including a reduction based on 2 or more standard deviations from the average price.

Once a target is identified, pricing software may be used to determine the best pricing available and to set a reduced price point. The group, represented by a common agent, would then propose to one or more purveyors of the target a desire to purchase at a particular point, or potentially face a boycott or other purchasing decisions by the members of the group.

A product would be identified in a number of ways including whether it reached a sufficient number of members' wish lists to initiate a pricing event.

Once the membership reached a sufficient number of members and a product was identified, the social media site would announce a membership boycott of a seller at step 40 or propose a member purchase option at step 38. These pricing actions may be directed to a product or a seller in a pre-determined region. The sellers would then have a period of time to meet the negotiated price and upon agreement, would present a coupon, or other code enabling those buyers to obtain the negotiated price. Alternatively, once a critical mass of members desirous of a particular product is achieved, sellers are notified and given the opportunity to offer a lower price, or potentially face a boycott of the good or seller. The operator of the site would obtain fees associated with the successful purchase of the item by a member in the form of a percentage or other remuneration.

Competitors of the boycotted entity would be entitled to meet or beat the pricing proposal and would not face a boycott so long as they acted in a timely and committed manner.

As the membership grows, the collection of members could also initiate a buying mode with a group of competitors to price a specific product at a point desired by members.

In other settings, a group would be formed with its purpose to boycott a particular seller or product until the price of other terms were proposed that were acceptable.

In another embodiment, the same system may be used to achieve a political goal whereby members petition the government for a particular result, and organize a boycott of a representative, or a seller of goods that has influence on a particular political issue.

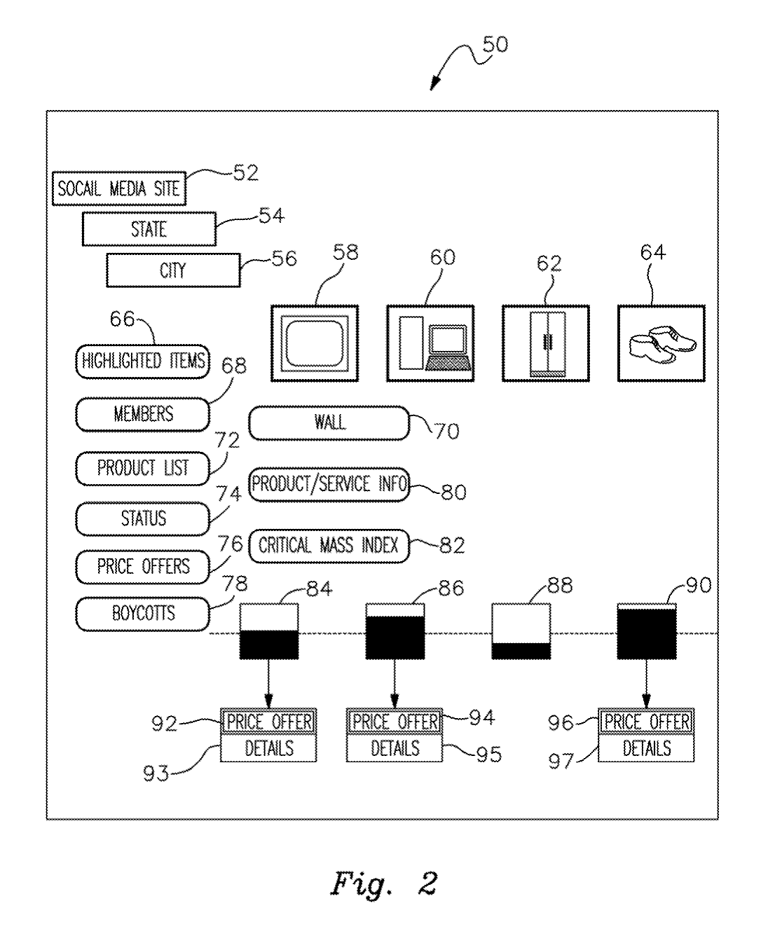

FIG. 2 shows a schematic diagram of a screen shot 50 from a website of the present system. Various pull down menus are displayed on social media site 52, to locate a region such as a state 54, and city 56. These may be further detailed by regions within a city, or any other geographical subdivision. From such regions, a membership group may be developed. The members may select a highlighted item 66 from a group of pull down menus or may be suggested by other members as well. Products may be presented at the top of the page from which members can select items 58, 60, 62 or 64 as shown. By way of example, item 58 is a grouping of electronics represented by a television set, item 60 is a grouping of computer products represented by a personal computer, item 62 is a grouping of appliances represented by a refrigerator, and item 64 is a grouping of clothes represented by a pair of shoes. Product/service information 80 is presented and members are shown a critical mass index 82 showing the popularity of a membership item as it reaches a sufficient number of members to justify a pricing action.

Wall 70 is available for posting by members of comments, questions or any other information, Wall 70 may also be used by the operator to post information of value to the membership.

Exemplary items 84, 86, 88 and 90 are shown in various states of popularity. Item 84, 86 and 90 are shown with a level exceeding the critical mass and warrant a potential pricing action. Item 88 is shown with insufficient numbers to justify an action.

For items 84 and item 86 a pricing offer is generated by the pricing tool and the member is shown a price offer 92 or 94 with purchasing details 93 and 95. Members may then avail themselves of the particular item at the designated price that has been agreed upon by the seller. Item 88 is shown at a point lacking a critical mass so members can see progress of the item and make further selections to move it into a critical mass categorization.

Item 90 is shown with a popularity reaching a critical mass but may be a case where the seller of the good or service has not agreed to any pricing point triggering the call for a boycott of that seller at 96 with details at 97. Boycotts may be shown at boycotts 78 which lists items of sufficient popularity to warrant a boycott and for which no seller has agreed to a price reduction. In other instances, a boycott is called without seller involvement at the outset. Members are thus in a position to boycott a particular seller of goods or services, or a particular product which can then be communicated via the social media site to the members, Members may also be advised of any follow up actions by the sellers to offer the good or service at a reduced and acceptable price.

As can readily been appreciated, if a sufficient number of members organize into a boycott group, economic buying influence may be achieved to place the consumer members on more equal footing with the seller of goods or services. Further with the aggregation of information available on the internet and through the collected knowledge of thousands of members, pricing of goods may better approximate a true market price since buyer information will be more equal to seller information.

On the side of the social media site, members may be identified by class, numbers or other membership criteria, but typically would remain anonymous to all other users. Product lists 72 may be available via pull down menu, as well as current critical mass status 74, any pricing offers 76 or boycotts 78 for product not currently shown on the home page as depicted with items 84, 86. 88 and 90.

Other features of social media or networking sites may be employed that are well known in the art such as like buttons, advertising, news feeds, etc.

As a product, service, or issue reaches a critical mass or sufficient quantity of members seeking same, the website announces a pricing action and informs users of either a reduced price being offered, or the initiation of a boycott of the good or the service or the provider of such goods or services. Upon acceptance of a pricing action, members may be provided a code or coupon to purchase the item within a specified period of time.

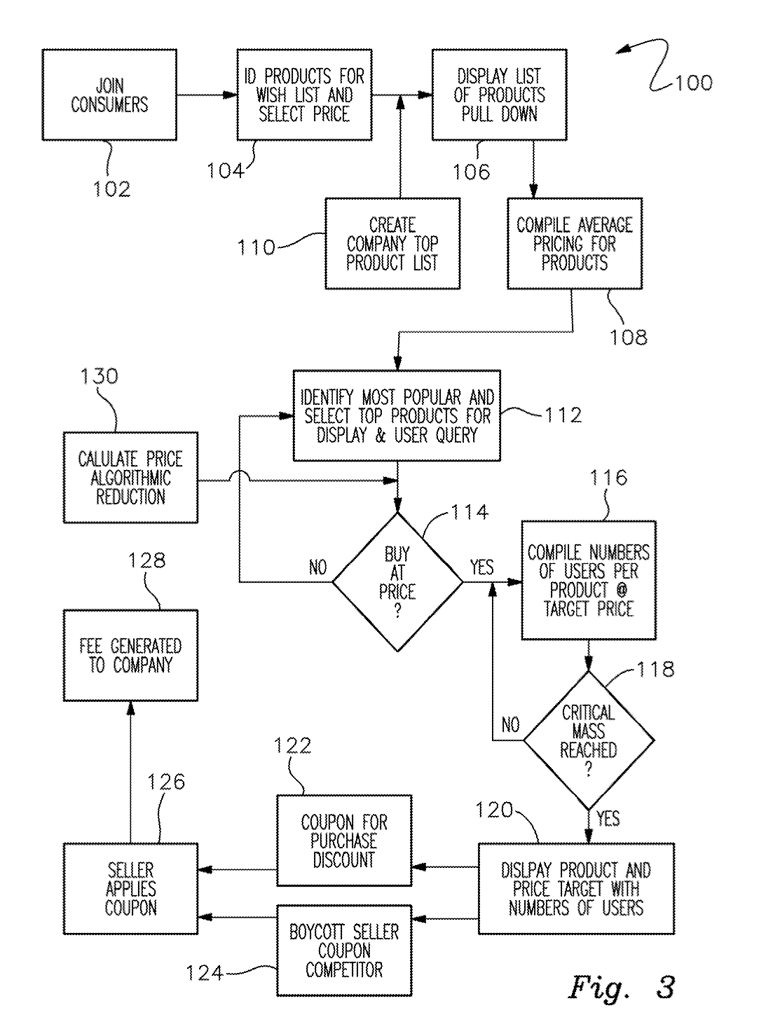

Turning now to FIG. 3, there is shown a flow chart of the steps involved in a pricing or boycott decision according to a preferred embodiment of the invention. Flow 100 begins with members or consumers joining at step 102. Step 104 enables the users to identify products for their wish list and select desired pricing for the particular item. Step 110 also permits the operator of company to display for the users top product lists based on Internet or other sources for users to consider. At step 106, the user is presented with a display of pull down menus for various product categories and individual products.

Step 108 compiles average pricing for the various products based on publicly available information on the Internet from sources such as Price Grabber™ and other databases of current product pricing. For example, a relationship could be formed with a product reviewing entity that compiles pricing and ratings to provide suggested products that meet certain criteria and achieve a higher rating. From this information, the site can display the current average price to give the user a baseline from which to identify a price at which he/she will buy the product. Alternatively, the site may calculate a reduced price using an algorithmic approach such as reducing the average by a number of standard deviations or any other statistically based calculation. In other cases, the proposed price may be calculated from the users desired pricing inputs, discussed in step 112, based on selecting a purchase price at which a sufficiently large percentage of the user group desires to purchase the product.

Step 112 identifies the most popular products from the wish lists and or the Internet or other sources, and displays them for query of the users of a desired price. Users are then queried at step 114 whether they would purchase the item at the selected target price developed through step 130 which calculates the desired price by averaging user inputs and, in some cases, reducing them by a algorithmic method such as dropping the price by a multiple of standard deviations from the average available price. In this way, the system provides users with a price that a sufficient number have indicated they would purchase the item at, or alternatively with a reduced price over the current average available price to present to the seller for consideration.

At step 114, after the user is queried whether they would purchase at a particular price, the user is given a yes or no decision. If it chooses yes, the information is compiled at step 116, if no, the user is presented with other choices from the identified list of step 112. At step 116, the system calculates the numbers of users at a target price and sends that information to step 118 where a critical mass is determined. If a critical mass is not reached, the system continues to compile at step 116 and presents graphically the current status of the user sentiment as shown in FIG. 2, item 88 for example where a critical mass has not been reached. If on the other hand, step 118 is an affirmative, the system displays at step 120 the product and its status of reaching a critical mass as shown in items 84, 86, and 90.

At step 122 based on the user input and calculated price, a seller is approached to accept the buying decision of the users and a coupon is generated that enables a user to purchase the product at a pre-determined price. In an alternative scenario, if the seller does not accept the buying decision, a boycott may be called of the seller at step 124 and coupon generated for a competitor to honor. As is readily apparent, if a boycott is called, the seller may decide to then accept the coupon and sell the goods at the price generated by the system. In either case, at step 126 the ultimate seller applies the coupon to the purchase of the goods or services and remits a percentage of the transaction to the company. Other mechanisms are available for the company to receive a payment in connection with the sale of goods such as membership fees based on successful product sales, direct payment by the sellers, or potentially an access fee by sellers to information about consumer choices to then effectuate their own transaction with the membership.

As discussed earlier, there may be cases where a political issue could be the ultimate issue of interest to users, but where economic pressure is applied through the boycott mechanism on products or services associated with individuals having political power or influence over such figures. In certain situations, political figures are also associated with businesses or other entities where a boycott of the economic interest may motivate a change in a political setting. This may be of particular value in countries where political leaders and their allies run or own various industries and can be influenced through their economic interests where political mechanisms fail. This system may provide an anonymous vehicle for voters or consumers to effect political change without going to the streets to protest and risk their lives.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All of the compositions and/or methods disclosed and claimed herein can be made and executed without undue experimentation in light of the present disclosure. While the compositions and methods of this invention have been described in terms of various embodiments, it will be apparent to those of skill in the art that other variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. A system for pricing goods or services comprising:
i. a database of members;
ii. a social networking site of said members having member input pertaining to goods or services;
iii. said members identify one or more products or services they desire to purchase at a desired price;
iv. a processor determining whether a good or service is desired by a sufficient number of members to justify bidding on that good or service; and
v. communication of said members' desire to a purveyor of such goods or services at a target price.

2. The system for pricing goods or services as claimed in claim 1 further comprising a price calculator that creates a target price based on data pertaining to said desired prices.

3. The system for pricing goods or services as claimed in claim 1 further comprising a generator of a target price that is a pre-determined amount below the average publicly available price.

4. The system for pricing goods or services as claimed in claim 1 further comprising a wish list for a member of desired goods or services.

5. The system for pricing goods or services as claimed in claim 1 further comprising a display of selected products for boycott of said members.

6. The system for pricing goods or services as claimed in claim 1 further comprising acceptance of said price by said purveyor or boycott of such purveyor by said members.

7. A method for pricing goods or services comprising:
i. storing a database of members in a data storage system;
ii. networking said members via the internet with member input pertaining to goods or services;
iii. identifying one or more products or services by members they desire to purchase;
iv. processing whether a good or service is desired by a sufficient number of members to justify bidding on that good, or service;
v. communicating said member& desire to a purveyor of such goods or services a target price; and
vi. demanding said price by said purveyor or boycotting such purveyor by said members.

8. The method for pricing goods or services as claimed in claim 7 further comprising the step of tying a selected issue of member interest to the negotiation with said purveyor.

9. The method for pricing goods or services as claimed in claim 7 further comprising the step of displaying products meeting rating criteria.

10. The method for pricing goods or services as claimed in claim 7 further comprising the step of supplying a purchaser coupon for selected goods or services.

11. The method for pricing goods or services as claimed in claim 7 further comprising the step of generating a target price for selected goods or services.

12. The method for pricing goods or services as claimed in claim 7 further comprising the step of pricing based on average available price on the internet during any given pre-determined time period.

13. The method for pricing goods or services as claimed in claim 7 further comprising the step of setting a pre-determined number of users desiring a particular product for calling a boycott.

14. A system for pricing goods or services comprising:
i. a database of members;
ii. a social networking site of said members having member selected price points pertaining to goods or services;
iii. said members identify one or more products or services they desire to purchase at said price point;
iv. a processor determining which good or service is desired by a sufficient number of members to bid upon at a determined price;
v. communication of said determined price to a purveyor of such goods or services; and
vi. demand on said purveyor to sell said goods or services at said price.

15. The system for pricing goods or services of claim 14 further comprising negotiation with said purveyor of an agreed upon price for said goods or services.

16. The system for pricing goods or services of claim 14 further comprising a boycott of said purveyor of goods or services.

17. The system for pricing goods or services of claim 14 further comprising communicating to a competitor of said purveyor the determined price to permit said competitor to negotiate the sale of goods or services.

18. The system for pricing goods or services of claim 14 further comprising a pricing calculator to set a target price based on a discount from average available price.

19. The system for pricing goods or services of claim 14 further comprising a boycott by said members of said purveyor.

20. The system for pricing goods or services of claim 14 further comprising a coupon related to said determined price for purchase of said goods or services.
